(19) United States
(12) Patent Application Publication
(10) Pub. No.: US 2026/0241516 A1
(43) Pub. Date: Aug. 20, 2026

(54) SHARPENING SYSTEM FOR A CUTTING TOOL AND RELATED METHOD OF USE

(71) Applicant: Ranch Distribution Inc, Edmonton (CA)

(72) Inventors: Donald Spencer WAUGH, Hamilton (CA); Darian Leo Tucker Tomas, Edmonton (CA)

(21) Appl. No.: 19/054,046

(22) Filed: Feb. 14, 2025

(51) Int. Cl. B24D 15/08; G01B 3/56

(52) U.S. Cl. CPC B24D 15/08; G01B 3/56

(57) ABSTRACT

A cutting tool sharpening system comprises a base for supporting a blade of the tool in inclined orientation in which a cutting edge is above an opposite side of the blade and over the support surface; and a sharpener distinct from the base and configured for movement on the support surface, the sharpener having a planar grinding surface arranged to be perpendicularly upright to the support surface and configured to grind a cutting edge portion of the blade when the sharpener is moved relative thereto in a linear path across the surface. The system features a tool comprising slots representing different cutting angles to measure the blade's cutting angle. The sharpener features magnetic devices on an end of a handle, receptacles registered therewith, and a grinding pad with projections configured to magnetically attract to the devices and to be mateably received in the receptacles for removable mounting to the handle.

### TECHNICAL FIELD

The following relates generally to a sharpening system for a cutting tool and a related method of use, and more particularly to such a system and related method of use in which there is a tool for measuring a cutting angle of a blade of the cutting tool.

### BACKGROUND

Sharpening systems for cutting tools are well known. One such type of sharpening system is referred to in industry as a rolling sharpener system and comprises a support base for supporting a blade of the cutting tool in an inclined orientation relative to an underlying support surface and a rollable sharpener that has a planar grinding surface oriented perpendicularly upright to the support surface and configured for rolling movement across the support surface. The planar grinding surface is placed in butting frictional engagement with the blade such that upon rollably displacing the sharpener relative to the blade, typically in a reciprocal linear motion, a face of the blade adjacent the cutting edge is ground, thereby sharpening the cutting edge.

A common type of cutting tool, such as a kitchen knife for food preparation, may be manufactured to have different cutting angles, each particularly suited for slicing a prescribed item, in this case, a foodstuff. Accordingly, the support base of a rolling sharpener system typically has more than one sidewall at which a blade of a cutting tool may be supported in the inclined orientation, each sidewall corresponding to a different predetermined cutting angle so that a blade with a corresponding cutting angle may be positioned with its blade face adjacent the cutting edge in perpendicularly upright relation to the support surface. However, the cutting angle of the cutting tool is often not readily known or indicated, and grindingly sharpening the blade at a different angle than the manufactured cutting angle may be problematic.

### SUMMARY

According to an aspect of the invention, there is provided a sharpening system for a cutting tool having a blade, wherein the blade extends longitudinally along a generally linear path and having opposite longitudinally extending sides and a cutting edge portion along at least one of the sides, wherein the cutting edge portion has opposite planar faces oriented in converging fashion and meeting at a cutting edge of the cutting edge portion, wherein the blade has a body portion adjacent the cutting edge portion and having opposite planar faces oriented in substantially parallel condition to each other, wherein the opposite planar faces of the cutting edge portion respectively form a common acute angle with planes containing the adjacent planar faces of the body portion that defines half of a cutting angle of the blade, the sharpening system comprising:
a support base for supporting the blade in inclined orientation relative to a support surface in which the cutting edge is above an opposite one of the sides of the blade, wherein the support base includes:
   an underside defining a plane arranged for resting on the support surface;
   a topside opposite to and above the underside; and
   a plurality of sidewalls extending upwardly and outwardly from the underside towards the topside as to be arranged to be inclined relative to the support surface, wherein the sidewalls respectively form different acute angles relative to the plane of the underside;
   wherein the support base is configured to removably receive the blade in the inclined orientation at each of the sidewalls;
a sharpener distinct from the support base and configured for movement on the support surface, wherein the sharpener comprises a planar grinding surface arranged to be oriented perpendicularly upright to the support surface, wherein the grinding surface is configured to grind the cutting edge portion of the blade when the sharpener is moved relative to the blade in a path following the cutting edge portion; and
a tool for measuring the cutting angle of the blade, wherein the tool comprises:
   a body carrying a plurality of slots representative of different cutting angles;
   wherein the slots respectively extend from open ends at a periphery of the body to closed ends spaced inwardly therefrom;
   wherein each of the slots comprises an opposite pair of sidewalls spaced apart in a width direction of the slot and converging at the closed end;
   wherein each of the slots comprises a mouth portion of the sidewalls forming the open end and in which the sidewalls extend linearly inwardly from the periphery of the body in converging fashion, wherein an angle between the sidewalls is associated with a respective one of the different cutting angles represented by the slot;
   wherein each slot further comprises an intermediate portion of the sidewalls in which the sidewalls are linear and parallel to each other, wherein at the intermediate portion the sidewalls extend inwardly from the mouth portion by a prescribed depth corresponding to convergence of imaginary lines collinear with the mouth portion, wherein at the intermediate portion the sidewalls are spaced apart by a prescribed width arranged to receive an end portion of the cutting edge portion including and adjacent to the cutting edge; and
   wherein each slot further comprises an end portion enlarged in the width direction relative to the intermediate portion and forming the closed end.

This provides an arrangement of sharpening system in which there is provided a measuring tool to identify or verify the cutting angle of the cutting tool's blade as to support the blade at a corresponding angle during grinding.

In one arrangement, the prescribed width is between 0.07 mm and 0.14 mm.

In one arrangement, the prescribed width is between 0.085 mm and 0.125 mm.

In the illustrated arrangement, the body of the tool for measuring the cutting angle is linearly elongated from a first longitudinal end to a second longitudinal end opposite thereto. Preferably, opposite longitudinally-extending sides of the body form parallel linear edges.

In one arrangement, the slots open at a common one of the longitudinally-extending sides of the body of the tool.

Preferably, the slots are arranged about the periphery of the body in consecutive order based on the angle between the sidewalls of the respective slots.

In the illustrated arrangement, the body of the tool for measuring the cutting angle is rectangular prismatic in shape.

In the illustrated arrangement, the body of the tool for measuring the cutting angle is in the form of a plate.

In the illustrated arrangement, a periphery of the support base, a shape of which is defined by the sidewalls, is a polygon. In one arrangement, the polygon has an odd number of sides.

In the illustrated arrangement, the end portion of each of the slots is rounded.

In the illustrated arrangement, the tool for measuring the cutting angle is configured to be removably attachable to the sidewalls of the support base to form a ledge therewith for supporting the blade of the cutting tool at a spaced height above the support surface.

In the illustrated arrangement, the support base is configured to emit magnetic fields at each of the sidewalls and the body of the tool is ferrous as to be magnetically attracted to the support base.

In one arrangement, the support base comprises plural support bases each with the sidewalls forming different acute angles relative to the support surface, and one of the support bases includes a top receptacle in the topside thereof sized and shaped to receive the underside of the other one of the support bases. In this manner, the plural support bases are stackable for storage.

According to another aspect of the invention there is provided a sharpening system for a cutting tool having a blade, wherein the blade extends longitudinally along a generally linear path and having opposite longitudinally extending sides and a cutting edge portion along at least one of the sides, wherein the cutting edge portion has opposite planar faces oriented in converging fashion and meeting at a cutting edge of the cutting edge portion, wherein the blade has a body portion adjacent the cutting edge portion and having opposite planar faces oriented in substantially parallel condition to each other, wherein the opposite planar faces of the cutting edge portion respectively form a common acute angle with planes containing the adjacent planar faces of the body portion that define half of a cutting angle of the blade, the sharpening system comprising:
a support base for supporting the blade in inclined orientation relative to a support surface in which the cutting edge is above an opposite one of the sides of the blade, wherein the support base includes:
   an underside defining a plane arranged for resting on the support surface;
   a topside opposite to and above the underside; and
   a plurality of sidewalls extending upwardly and outwardly from the underside towards the topside as to be arranged to be inclined relative to the support surface, wherein the sidewalls respectively form different acute angles relative to the plane of the underside;
   wherein the support base is configured to removably receive the blade in the inclined orientation at each of the sidewalls;
a sharpener distinct from the support base and configured for movement on the support surface, wherein the sharpener comprises a planar grinding surface arranged to be oriented perpendicularly upright to the support surface, wherein the grinding surface is configured to grind the cutting edge portion of the blade when the sharpener is moved relative to the blade in a path following the cutting edge portion;
wherein the sharpener comprises:
   a handle arranged for gripping by a user, wherein the handle has an axis arranged to be parallel to the support surface and having axially opposite ends;
   wherein the handle is supported for rolling movement across the support surface;
   a pair of magnetic devices configured to emit magnetic fields and supported at a common one of the ends of the handle in spaced apart relation transversely of the axis;
   a pair of receptacles respectively registered with the magnetic devices such that each of the magnetic devices is recessed relative to an axially outwardly facing end of a respective one of the receptacles; and
   a grinding pad comprising the planar grinding surface on an outer side thereof and a mounting portion on an opposite inner side, wherein the mounting portion forms a pair of projections which are configured to magnetically attract to the magnetic devices, wherein the projections are sized and shaped to be mateably received in the receptacles such that the grinding pad is removably mountable to the handle.

This provides an arrangement of sharpening system in which the grinding pad of the sharpener is quickly interchangeable with a like grinding pad having a different level of abrasiveness.

Preferably, the projections are ferrous, as to magnetically attract to the magnetic devices.

Preferably, the grinding pad includes at a periphery encompassing the outer and inner sides a notch formed adjacent the inner side as to form in a mounted position of the grinding pad, in which the grinding pad is connected to the handle, a receptacle arranged to receive a prying implement to pull the grinding pad away from the handle. For example, the prying implement is a user's fingertip.

Preferably, the sharpener further includes wheels at the axially opposite ends of the handle and supporting the handle in said rolling movement, wherein one of the wheels at said common end of the handle forms the receptacles such that the grinding pad is rotatable with the wheel in rolling movement on the support surface.

In the illustrated arrangement, the receptacles are formed through a full thickness of the wheel directed along the axis of the handle, and the magnetic devices are received at an inner side of the wheel facing the handle.

In the illustrated arrangement, inner end portions of the receptacles opening at the inner side of the wheel and receiving the magnetic devices are radially enlarged relative to outer end portions of the receptacles opening at an outer side of the wheel and arranged to receive the projections of the grinding pad, such that the receptacles include intermediate ledges for butting engagement with the magnetic devices to retain the magnetic devices in the inner end portions.

According to yet another aspect of the invention there is provided a method of using a sharpening system to grindingly sharpen a cutting tool, wherein the cutting tool has a blade extending longitudinally along a generally linear path and having at one or more longitudinally-extending sides thereof a cutting edge portion with opposite planar faces oriented in converging fashion to meet at a cutting edge, the method comprising:
measuring the cutting angle of the blade;
based on the measured cutting angle of the blade, supporting the blade in a prescribed inclined orientation in which the cutting edge is above an opposite one of the sides of the blade, wherein an angle of the prescribed inclined orientation is an acute angle relative to a support surface and equal to 90 degrees less the measured cutting angle;
while the blade is supported in the prescribed inclined orientation, grinding one of the planar faces of the cutting edge portion.

This provides an arrangement to sharpen the blade in a manner maintaining the manufactured cutting angle thereof.

In the illustrated arrangement, measuring the cutting angle comprises comparing the cutting edge portion with one or more slots representative of different predetermined cutting angles to identify the cutting angle of the blade.

In the illustrated arrangement, comparing the cutting edge portion with the slots comprises inserting the cutting edge portion into said at least one of the slots.

When the sharpening system includes a support base having a plurality of inclined sidewalls forming different angles with a plane defining an underside of the support base, supporting the blade in the prescribed inclined orientation based on the measured cutting angle may comprise placing the blade in butting engagement with one of the sidewalls of the support base forming said angle of the prescribed inclined orientation, as in the illustrated arrangement.

When the sharpening system includes a measuring tool for measuring the cutting angle of the blade that is distinct from the support base, and when the blade is shorter in height between the cutting edge and the opposite longitudinally-extending edge than the sidewalls of the support base, supporting the blade in the prescribed inclined orientation may comprise supporting the measuring tool at or adjacent a bottom of said one of the sidewalls to form a ledge at a top of the measuring tool for engaging the opposite longitudinally-extending side of the blade in the prescribed inclined orientation, as in the illustrated arrangement.

When the sharpening system includes a grinding sharpener supported for rolling movement on the support surface, and when the sharpening system includes a support base with at least one sidewall for supporting the blade in the prescribed inclined orientation, the illustrated arrangement of method further includes, after grinding one of the planar faces of the cutting edge portion, storing the sharpener with its rotational axis oriented upright in a top receptacle in the support base.

These and other aspects are contemplated and described herein. It will be appreciated that the foregoing summary sets out representative aspects of the invention to assist skilled readers in understanding the following detailed description.

### DESCRIPTION OF THE DRAWINGS

A greater understanding of the embodiments will be had with reference to the Figures, in which:

FIG. 1 is a perspective view of an arrangement of sharpening system according to the present invention;

FIG. 2 shows an example of cutting tool, specifically in the form of a kitchen knife;

FIG. 3 is a cross-sectional view along line 3-3 in FIG. 2;

FIG. 4 is a side view of a support base of the arrangement of sharpening system with a blade of the cutting tool in an inclined orientation;

FIG. 5 is a bottom plan view of the support base of FIG. 4;

FIG. 6 is a top plan view of the support base of FIG. 4;

FIG. 7 is another side view of the support base of FIG. 4;

FIG. 8 is an elevational view of a measuring tool of the arrangement of sharpening system of FIG. 1;

FIG. 9 is an enlarged partial view of area I in FIG. 8;

FIGS. 10A through 10C show comparison of the cutting edge portion of the blade to a slot as to measure the cutting angle;

FIG. 11 is a side view of the measuring tool of FIG. 8;

FIG. 12 is a side view of a support base of the arrangement of sharpening system with the measuring tool positioned to boost a blade of the cutting tool in the inclined orientation;

FIG. 13 is a side view of the support base with the measuring tool in the position shown in FIG. 12, with the cutting tool omitted for clarity of illustration;

FIG. 14 is another side view of the support base with the measuring tool as shown in FIG. 13;

FIG. 15 is a side view of the sharpener;

FIG. 16 is a cross-sectional view along line 16-16 in FIG. 14;

FIG. 17 is an end view of the sharpener;

FIG. 18 is an exploded view of the sharpener;

FIG. 19 is a perspective view of an auxiliary support base; and

FIG. 20 is a top plan view of the auxiliary support base of FIG. 19.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

The accompanying figures show a sharpening system 100 for a cutting tool 1 similar in form to a kitchen knife. That is, the cutting tool 1 generally comprises a blade 2 extending longitudinally along a generally linear path and having opposite longitudinally extending sides 3 and a cutting edge portion 4 along at least one of the sides 3. The blade 2 extends along a generally linear path in that the blade is substantially linearly elongated between opposite ends 5 thereof, at least one of which is supported by a handle 6 configured for gripping by a user, but the sides 3 are not necessarily straight. In the illustrated arrangement, the blade 2 extends along the generally linear path from the handle 6 to a tip 9 of the blade at which the sides 3 converge and which is free, that is, the blade is supported by a single handle. In the illustrated arrangement, the handle 6 is elongated in the longitudinal direction of the blade such that the handle and blade are arranged end-to-end.

Still referring to the cutting tool, the cutting edge portion 4 has opposite planar faces 4A oriented in converging fashion and meeting at a cutting edge 4B. Further, the blade has a body portion 12 adjacent the cutting edge portion 4 and having opposite planar faces 12A oriented in substantially parallel condition to each other, that is, the faces 12A of the body portion are generally uniformly spaced apart across their surface areas. The opposite planar faces 4A of the cutting edge portion respectively form a common acute angle γ with planes P_{B} containing the adjacent planar faces 12A of the body portion that defines half of a cutting angle θ of the blade. That is, the blade cutting angle θ=2γ. In the illustrated arrangement of cutting tool, the body portion terminates at a flat edge 12B opposite the cutting edge 4B and which is not suited for slicing or cutting action. Generally speaking, the cutting angle θ is predetermined by a manufacturer of the cutting tool, and it is desirable to maintain the predetermined cutting angle when sharpening.

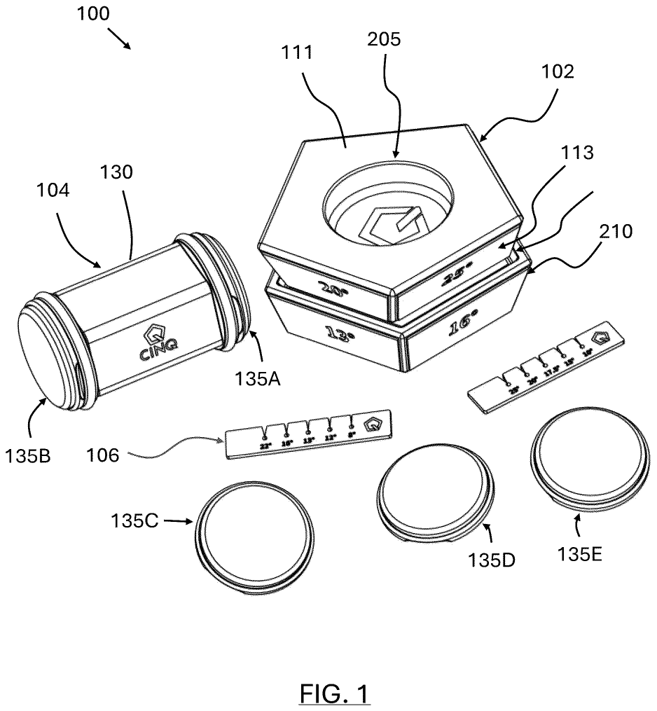

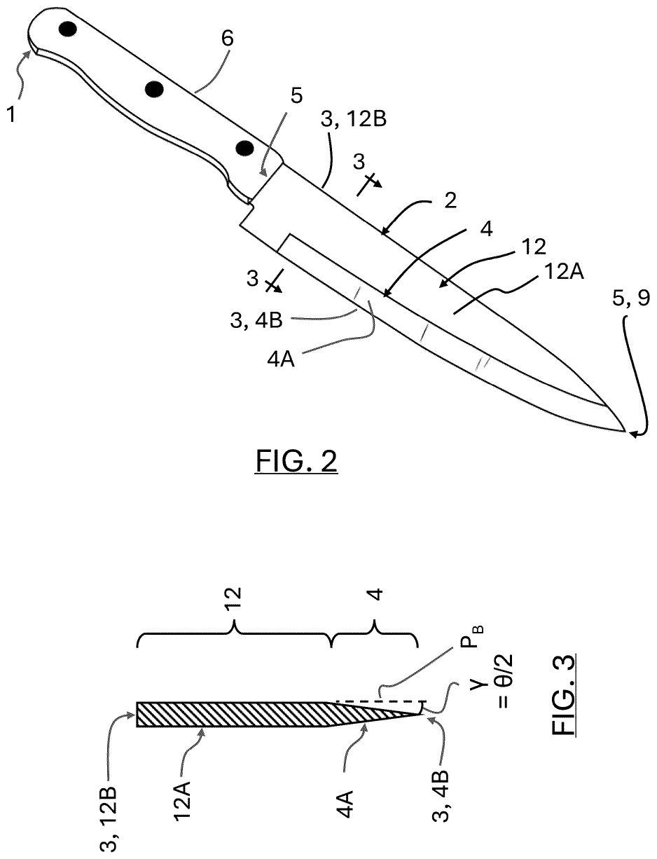

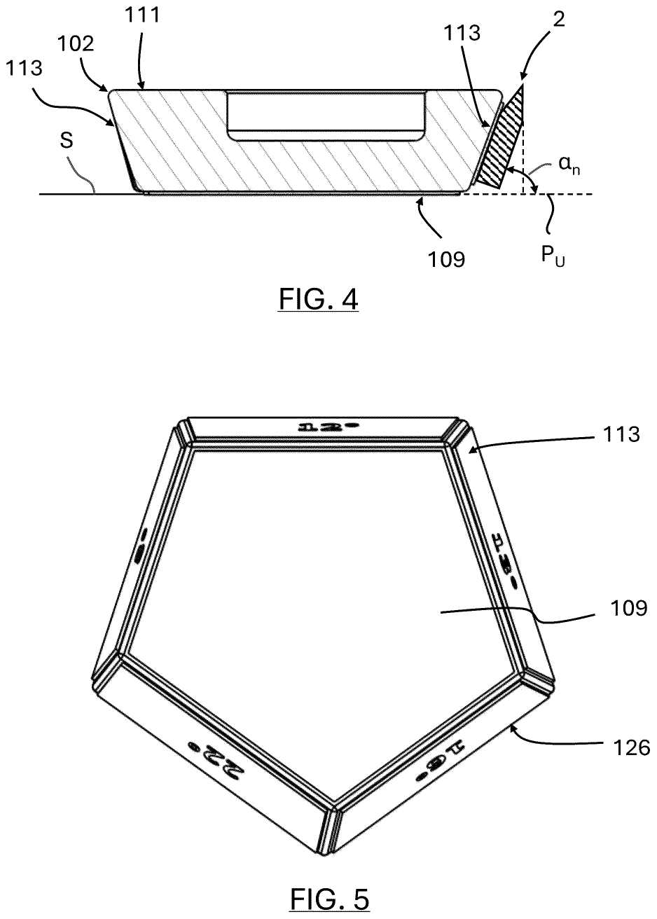

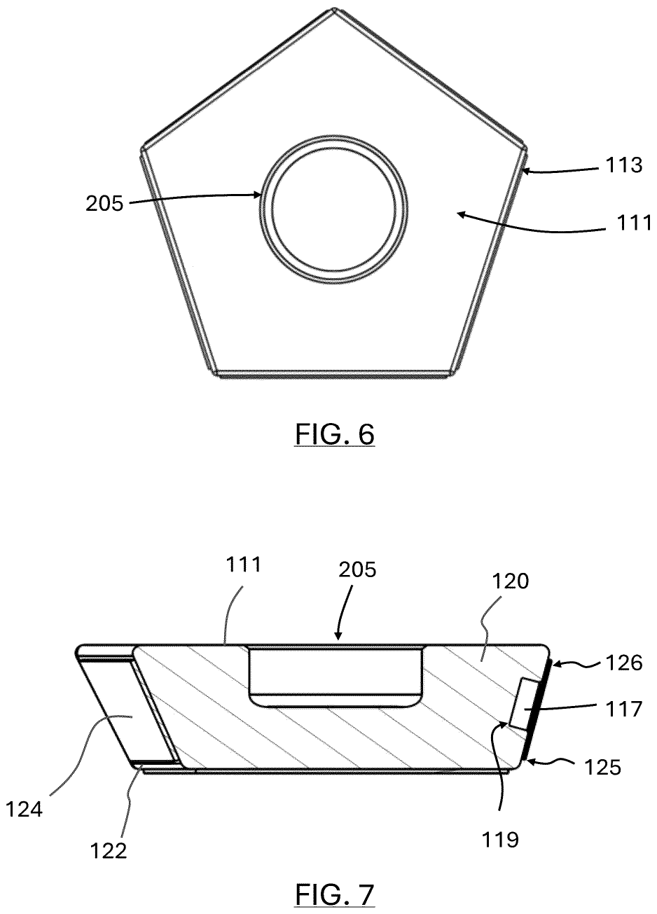

Turning now to the sharpening system 100, and with reference to FIG. 1, the system generally comprises a support base 102 for supporting the blade 2 in inclined orientation relative to a support surface S, as more clearly shown in FIG. 4, in which orientation the cutting edge 4B is above an opposite one of the sides 3 of the blade; a sharpener 104 distinct from the support base 102 and configured for movement on the support surface S during which the sharpener is usable to grindingly sharpen one of the faces 4A of the cutting edge portion; and a tool 106 for measuring the cutting angle θ of the blade. It will be appreciated that in the inclined orientation the blade is oriented generally horizontally in that the blade is oriented more horizontal than upright, such that its sides 3 extend substantially horizontally and the opposite blade ends 5, one of which defines the tip 9, are disposed in horizontally opposed relation to each other. Furthermore, there is a prescribed version of the inclined orientation in which an angle thereof is an acute angle relative to the support surface and equal to 90 degrees less the cutting angle of the blade.

Turning initially to the support base 102, this comprises an underside 109 defining a plane P_{U} arranged for resting on the support surface S; a topside 111 opposite to and above the underside; and a plurality of sidewalls 113 extending upwardly and outwardly from the underside 109 towards the topside 111 as to be arranged to be inclined relative to the support surface S. The sidewalls 113 respectively form different acute angles αₙ, where n is a number of the sidewalls 113, relative to the plane P_{U} of the underside. In the illustrated arrangement, a periphery of the support base, a shape of which is defined by the sidewalls 113, is a polygon, in particular with an odd number of sides, such that there are an odd number of sidewalls. More specifically, in the illustrated arrangement, there are five sidewalls forming five distinct acute angles α₁ through α₅ with the support surface S. Further, the sidewalls 113 are arranged about the periphery of the support base in consecutive order based on the acute angle α₁ through α₅ besides the sidewalls representing the smallest and largest angles, which are located adjacent.

Further, the support base 102 is configured to removably receive the blade 2 in the inclined orientation at each of the sidewalls 113. In the illustrated arrangement, the support base 102 is configured to emit magnetic fields at each of the sidewalls, for example, by having magnetic devices 117 such as permanent magnets supported at the sidewalls. More specifically, the magnetic devices 117 are supported in receptacles 119 formed in a body 120 of the support base at each of the sidewalls 113, and covers 122 are provided over the devices 117 in the receptacles to provide a smooth planar surface 124 for engaging the blade 2 of the cutting tool. The smooth planar surface 124 spans substantially from a bottom 125 to a top 126 of the sidewall, that is, a majority height of the sidewall and extends across a midpoint of the sidewall. Furthermore, it will be appreciated that the body 120 of the support base is sized and shaped to provide the topside, underside and the sidewalls.

Turning now to the sharpener 104, this comprises a planar grinding surface 127 arranged to be oriented perpendicularly upright to the support surface S. The grinding surface 127 is configured to grind the cutting edge portion 4 of the blade when the sharpener is moved relative to the blade 2 in a path following the cutting edge portion 4. Since the blade 2 extends linearly between its opposite ends 5, the sharpener is displaced in a linear path across the support surface.

The sharpener 104 includes a handle 130 arranged for gripping by a user and having an axis A_{H} arranged to be parallel to the support surface S. The handle 130 has axially opposite ends 132 and is supported for rolling movement across the support surface. The grinding surface 127 is located at one of the ends 132 and is oriented perpendicularly transversely to the handle axis A_{H}.

In the illustrated arrangement, the sharpener 104 includes plural grinding pads, in this case indicated at 135A through 135E, each providing a grinding surface to be located at one of the handle ends 132. The grinding surface of each pad has a different abrasiveness, in this case by being texturized and locating a prescribed pattern of grinding projections, for successive use to grind the cutting edge portion 104. Yet further, since the handle 130 only has two axially opposite ends, the sharpener of the illustrated arrangement of sharpening system is configured to removably receive the grinding pads 135 for interchanging with other grinding pads of a set with more than two grinding pads of different abrasiveness.

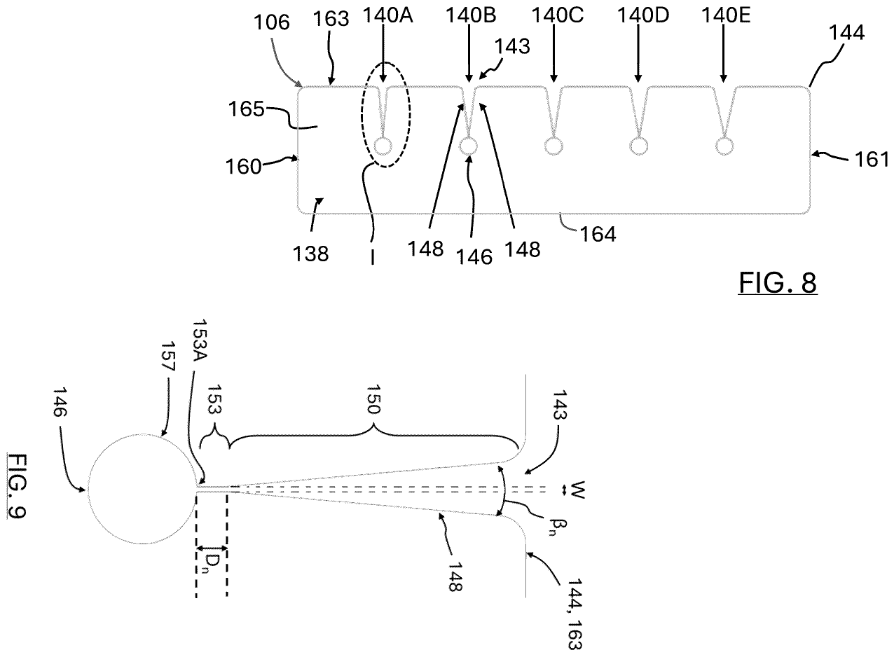

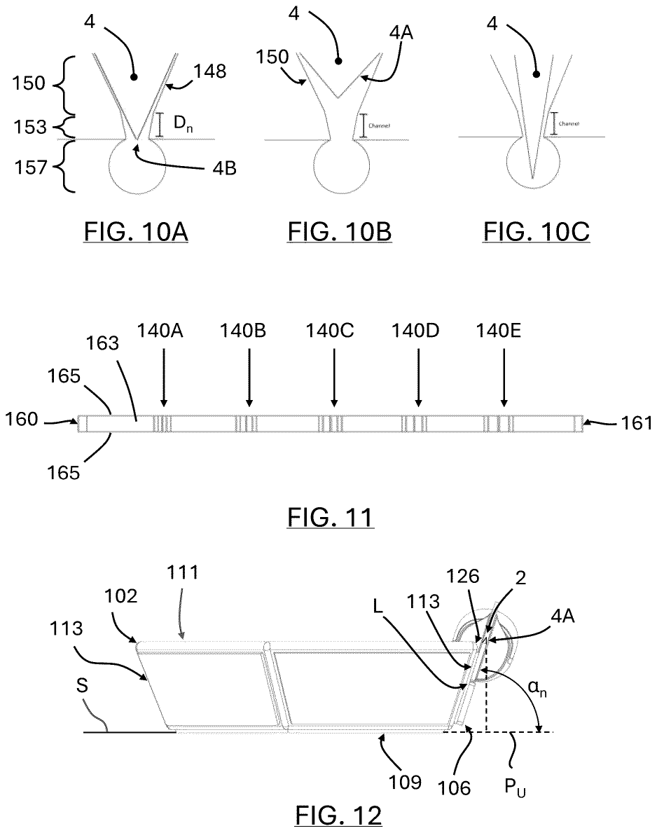

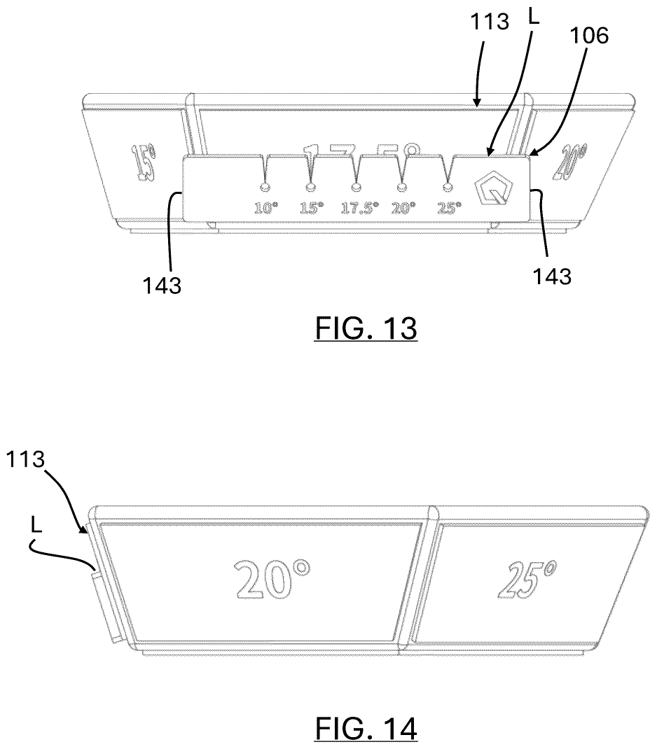

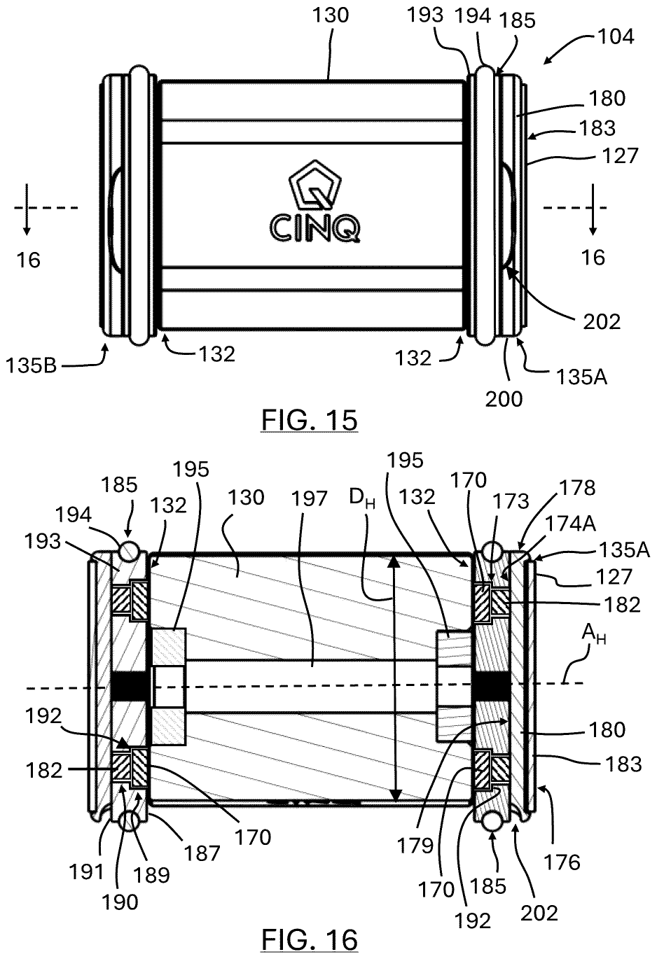

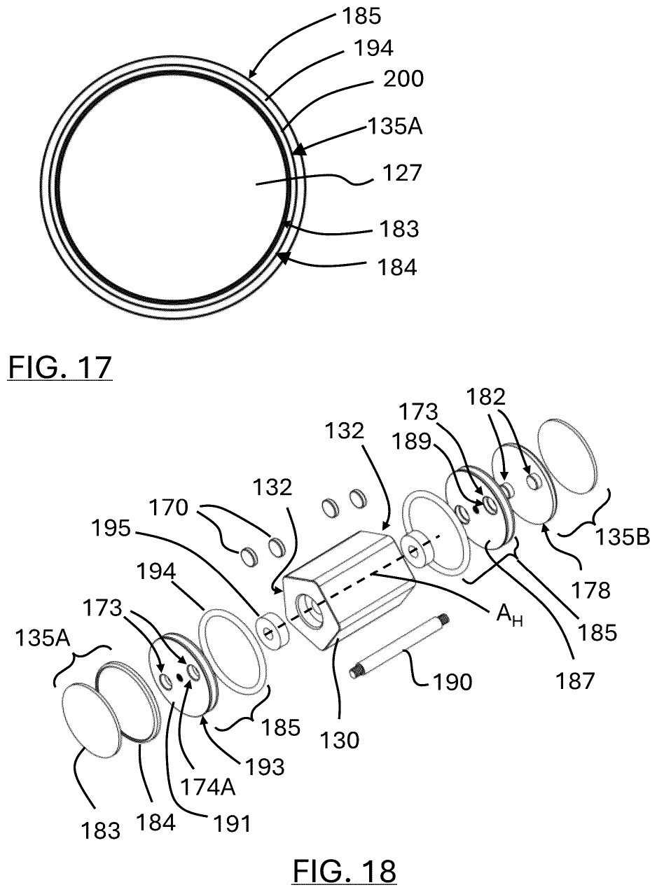

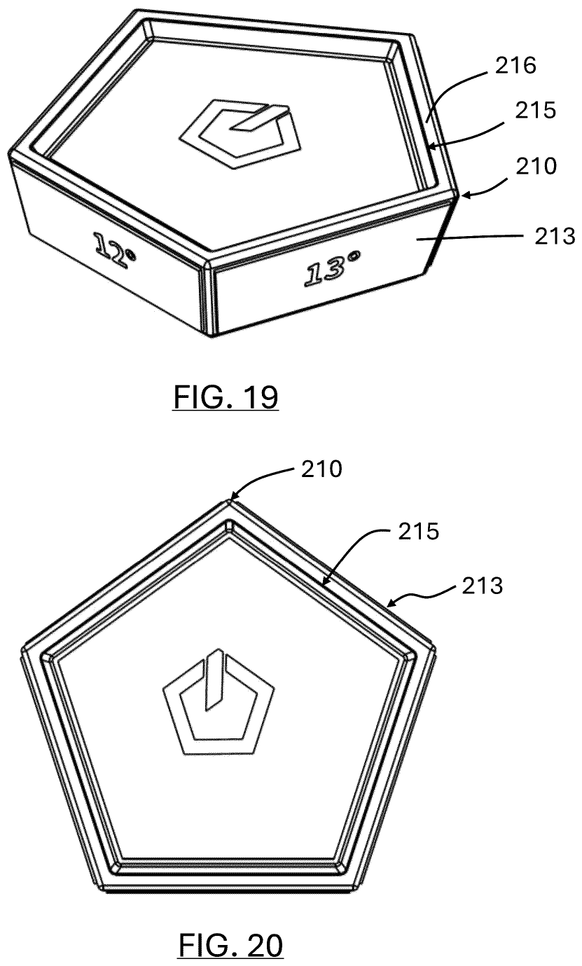

Turning now to the measuring tool 106, and referring to FIG. 8, the tool comprises a body 138 carrying a plurality of slots, in this case indicated at 140A through 140E, representative of different cutting angles. That is, the slots 140A through 140E are shaped to correspond to cutting edge portions of different cutting angles, such that by locating the cutting edge portion 4 of the cutting tool to be measured in one of the slots, the cutting angle thereof can be determined by matching to the slot providing a snug fit for the cutting edge portion.

The measuring slots 140A through 140E respectively extend from open ends 143 at a periphery 144 of the body 138 to closed ends 146 of the slots spaced inwardly from the periphery 144. Each of the slots comprises an opposite pair of sidewalls 148 spaced apart in a width direction of the slot and converging at the closed end 146.

With reference to FIG. 9, to receive the cutting edge portion of a blade, each of the slots comprises a mouth portion 150 of the sidewalls 148 forming the open end 143 and in which the sidewalls extend linearly inwardly from the periphery 144 of the body in converging fashion. An angle βₙ between the sidewalls at the mouth portion 150, where n is a number of the slots, is associated with a respective one of the different cutting angles θ represented by the slot. More specifically, the respective angle βₙ is equal to the respective cutting angle θ.

Each slot further comprises an intermediate portion 153 of the sidewalls 148 in which the sidewalls are linear and parallel to each other. At the intermediate portion, the sidewalls 148 extend inwardly from the mouth portion by a prescribed depth Dₙ corresponding to a convergence of imaginary lines collinear with the mouth portion 150. Furthermore, at the intermediate portion, the sidewalls are spaced apart by a prescribed width W arranged to receive an end portion of the cutting edge portion 4 including and adjacent to the cutting edge 4B, that is, the end portion of the cutting edge portion additionally includes end portions of the planar faces 4A. As such, if the blade 2 received in the slot matches the cutting angle represented thereby, its cutting edge 4B would be located substantially at an inward-most end 153A of the intermediate portion of the sidewalls.

It will be appreciated that in the illustrated arrangement the prescribed width of the intermediate portion of all of the slots 140A-140E is the same, and is at least between 0.07 mm and 0.14 mm, and more specifically may be between 0.085 mm and 0.125 mm. In contrast, the prescribed depth Dₙ differs amongst the slots as it corresponds to the angle βₙ between the sidewalls at the mouth portion 150.

Thus, if the measured blade's cutting angle is greater than the respective slot's angle βₙ, then inserting the blade into the slot will cause the cutting edge 4B to be located at the mouth portion, since the mouth portion of the sidewalls will abut the faces 4A of the blade and prevent movement further or deeper into the slot.

If the measured blade's cutting angle is smaller than the respective slot's angle β, then to enhance visual indication that the slot does not correspond to a measured blade, each slot further comprises an end portion 157 enlarged in the width direction relative to the intermediate portion 153 and forming the closed end 146. That is, at the end portion 157, the sidewalls initially diverge from the inward-most end 153A thereof at the intermediate portion and follows paths therefrom to eventually converge at the closed end 146. In the illustrated arrangement, the end portion 157 of each of the slots is rounded, for example, as to be substantially circular. That is, if an arc of common radius as the end portion 157 were drawn between the sidewalls at the inward-most end 153A as an extension of the paths of the sidewalls, the overall shape would be elliptical, specifically circular.

In the illustrated arrangement, the body 138 of the tool for measuring the cutting angle is linearly elongated from a first longitudinal end 160 to a second longitudinal end 161 opposite thereto, and opposite longitudinally-extending sides 163, 164 of the body form parallel linear edges. The slots are arranged about the periphery 144 of the tool body in consecutive order based on the angle βₙ between the sidewalls of the respective slots. Thus, movement between from a selected slot found not too match the blade's cutting angle to another for a subsequent measurement is more convenient. Further, the slots open at a common one of the longitudinally-extending sides, in this case 163. The body 138 is rectangular prismatic in shape such that the opposite ends 160, 161 form parallel linear edges, too. Furthermore, the body 138 is in the form of a plate such that the common side 163 locating the open ends 143 of the slots is a flat linear edge between opposite planar faces 165 of the body. Accordingly, the slots are formed through a full thickness of the body and across a partial width thereof as to have the closed ends 146 that are in spaced relation to an opposite one of the longitudinally-extending sides 164.

Since the measuring tool 106 is distinct from the base 102, it is conveniently available for use to selectively boost a blade of a cutting tool that is shorter than the sidewall, as to locate an outwardly facing one of the planar faces 4A of the cutting edge portion in line with or preferably outwardly of the top 126 of the sidewall. As such, the measuring tool 106 is configured to be removably attachable to the sidewalls 113 of the support base 102 to form a ledge L therewith for supporting the blade of the cutting tool at a spaced height above the support surface. Since the support base is configured to emit magnetic fields at each of the sidewalls, the body of the tool is ferrous as to be magnetically attracted to the support base. It will be appreciated that preferably the tool is sized longer between the ends 143 than widths of the sidewalls 113 such that end portions of the tool project beyond the sidewall for gripping by the user to remove the tool 106 from attachment to the support base sidewall.

Turning now in more detail to the sharpener 104, and further to the handle 130, the sharpener comprises a pair of magnetic devices 170 configured to emit magnetic fields, for example permanent magnets, and supported at a common one of the ends 132 of the handle in spaced apart relation transversely of the axis A_{H}. That is, each of the pair of magnetic devices 170 is radially spaced from the axis A_{H} and spaced from one another. In the illustrated arrangement, the magnetic devices 170 lie along a diameter D_{H} of the handle.

Further, the sharpener includes a pair of receptacles 173 respectively registered with the magnetic devices 170 such that each of the magnetic devices is recessed relative to an axially outwardly facing end 174A of a respective one of the receptacles 173.

It will be appreciated that each of the ends 132 of the handle include the magnetic devices 170 and the receptacles 173 to facilitate concurrent mounting of multiple grinding pads, in this case two, on the handle for sequential use by flipping the sharpener 180 degrees on its axis without interchanging pads.

Each grinding pad 135A-135E comprises a planar grinding surface 127 on an outer side 176 thereof and a mounting portion 178 on an opposite inner side 179. The mounting portion 178 forms a pair of projections 182 which are configured to magnetically attract to the magnetic devices 170. The projections 182 are sized and shaped to be mateably received in the receptacles 173 such that the grinding pad is removably mountable to the handle 130. In the illustrated arrangement, the projections 182 are ferrous, as to magnetically attract to the magnetic devices 170. In the illustrated arrangement, the grinding surface 127 is defined by a texturized plate 183 carried, for example by adhesion, on a face of a main body 184 defining the mounting portion 178.

To be movable on the support surface S, the sharpener further includes wheels 185 at the axially opposite ends 132 of the handle and supporting the handle 130 in rolling movement thereof. One of the wheels 185 at the common end 132 of the handle locating the magnetic devices 170 forms the receptacles 173 such that the grinding pad is rotatable with the wheel 185 in rolling movement on the support surface. In the illustrated arrangement, the receptacles 173 are formed through a full thickness of the wheel 185 directed along the axis A_{H} of the handle, and the magnetic devices 170 are received at an inner side 187 of the wheel facing the handle 130. Inner end portions 189 of the receptacles opening at the inner side 187 of the wheel and receiving the magnetic devices 170 are radially enlarged relative to outer end portions 190 of the receptacles opening at an outer side 191 of the wheel and arranged to receive the projections 182 of the grinding pad, such that the receptacles 173 include intermediate ledges 192 for butting engagement with the magnetic devices 170 to retain the magnetic devices in the inner end portions 189. The wheels 185 respectively include a hub 193 locating the receptacles and a ring 194 encompassing the hub and arranged for rollable engagement with the support surface S.

To permit the handle to remain stationary while the sharpener is rollably displaced on the wheels 185, the sharpener 104 includes bearings 195 at the ends 132 of the handle to rotatably support the same, and a rod 197 extending coaxially of the axis A_{H}, passing through the bearings 195, and rotatably interconnecting the wheels 185 to define an axle. Thus, the bearings 195 permit relative rotation between the handle 130 and the wheels 185, so that the handle 130 gripped by a user's hand can remain in fixed rotational position, that is stationary, while the wheels rotate in movement of the sharpener across the support surface S.

In a mounted position of the grinding pad 135A-135E in which the grinding pad is connected to the handle, the inner side 179 of the pad is placed in butting engagement with the outer side 191 of the wheel. To aid in removal for interchanging with a grinding pad of different abrasiveness, each grinding pad includes at a periphery 200 encompassing the outer and inner sides 176, 179 a notch 202 formed adjacent the inner side 179 as to form in the mounted position of the grinding pad a receptacle arranged to receive a prying implement, like a user's fingertip, to pull the grinding pad away from the handle. The notch 202 is formed in an otherwise substantially planar inner side 179 of the pad, besides the projections 182 which protrude from the inner side 179 for magnetic mating in the receptacles 173.

Thus is provided an arrangement of sharpening system in which there is provided a measuring tool to identify or verify the cutting angle of the cutting tool's blade as to support the blade at a corresponding angle during grinding.

Further, thus is provided an arrangement of sharpening system in which the grinding pad of the sharpener is quickly interchangeable with a like grinding pad having a different level of abrasiveness.

There is also disclosed herein a method of using a sharpening system 100 to grindingly sharpen a cutting tool 1 which has a blade 2 extending longitudinally along a generally linear path and having at one or more longitudinally-extending sides 3 thereof a cutting edge portion 4 with opposite planar faces 4A oriented in converging fashion to meet at a cutting edge 4B. The method generally comprises:
measuring the cutting angle θ of the blade 2;
based on the measured cutting angle θ of the blade, supporting the blade 2 in a prescribed inclined orientation in which (i) the cutting edge 4B is above an opposite one of the sides 3 of the blade, and (ii) an angle of the prescribed inclined orientation is an acute angle relative to the support surface S and equal to 90 degrees less the measured cutting angle θ;
while the blade 2 is supported in the prescribed inclined orientation, grinding one of the planar faces 4A of the cutting edge portion 4.

Measuring the cutting angle comprises comparing the cutting edge portion 4 with one or more slots such as those indicated at 140A-140E representative of different predetermined cutting angles to identify the cutting angle of the blade. More specifically, comparing the cutting edge portion with the slots comprises inserting the cutting edge portion into at least one of the slots.

Comparing the cutting edge portion comprises checking whether the shape of the cutting edge portion matches a flared opening of one of the slots. A snug fit between the cutting edge portion and the slot indicates that the cutting angle is the same or substantially the same as the angle of the flared slot opening. ‘Snug fit’ means that the sidewalls of the slot at the flared openings thereof mateably receive the cutting edge portion. If the cutting edge portion does not match the angle of the flared opening, then there will be a gap between the sidewalls and the planar faces 4A of the cutting edge portion causing the cutting edge 4B to be located too shallowly or too deeply into the slot. The slots are shaped to provide an enlarged end portion below the flared opening to receive the cutting edge 4B when the cutting angle of the blade is less than that of the flared opening.

Supporting the blade in the prescribed inclined orientation based on the measured cutting angle comprises placing the blade in butting engagement with one of the sidewalls 113 of the support base forming the angle of the prescribed inclined orientation with the support surface S. As such, an outwardly facing one of the planar faces 4A, that is, the face directed away from the support base 102, is presented for grinding. To grind the opposite face, the blade 2, and more generally speaking the cutting tool 1, is rotated 180 degrees (within a horizontal plane) to expose a previously inwardly-facing one of the faces 4A.

Depending on a height of the blade 2, supporting the blade 2 in the prescribed inclined orientation may comprise supporting the measuring tool 106 at or adjacent the bottom 125 of the sidewall 113 to form a ledge L at a top of the measuring tool for engaging the opposite longitudinally-extending side 3 of the blade in the prescribed inclined orientation.

After grinding the planar face 4A of the cutting edge portion 4, and preferably both of the faces 4A, the method may include a step of storing the sharpener 104 with its rotational axis A_{H} oriented upright in a top receptacle 205 in the support base 102. Since the grinding pads have ferrous portions, and the support base emits magnetic fields at its sidewalls 113, the grinding pads may be stored in magnetic attachment to the sidewalls 113.

Thus is provided an arrangement of method to sharpen the blade in a manner maintaining the manufactured cutting angle thereof.

In one arrangement of the sharpening kit, there are provided multiple support bases which are substantially the same. For example, there may be a primary support base such as that indicated at 102 and an auxiliary support base 210. The sidewalls of the multiple support bases 113, 213 respectively form different acute angles relative to the support surface, and to each other. In this manner, the overall set of all the sidewalls of the multiple support bases may provide a higher resolution of available inclination angles to more closely match the cutting angle of the blade.

When the sharpening kit has multiple support bases, one of the support bases, such as the auxiliary one 210, includes a top receptacle 215 in a topside 216 thereof sized and shaped to receive the underside 109 of the other support base, in this case the primary one 102. More specifically, the top receptacle 215 is sized and shaped to receive a bottom portion of the other support base 102 including the underside 109 and lower portions of the sidewalls 113. In this manner, the plural support bases 102, 210 are stackable for storage, in a configuration as shown in FIG. 1.

Further, when the sharpening kit has multiple support bases, there may be provided multiple tools for measuring the cutting angle of the blade, which are substantially the same but having slots corresponding to different cutting angles.

As described hereinbefore, the present invention relates to a cutting tool sharpening system comprising a base for supporting a blade of the tool in inclined orientation in which a cutting edge is above an opposite side of the blade and over the support surface; and a sharpener distinct from the base and configured for movement on the support surface, the sharpener having a planar grinding surface arranged to be perpendicularly upright to the support surface and configured to grind a cutting edge portion of the blade when the sharpener is moved relative thereto in a linear path across the surface. The system features a tool comprising slots representing different cutting angles to measure the blade's cutting angle. The sharpener features magnetic devices on an end of a handle, receptacles registered therewith, and a grinding pad with projections configured to magnetically attract to the devices and to be mateably received in the receptacles for removable mounting to the handle.

While the aspects of the present embodiments are illustrated and described as having a certain arrangement of aspects and features, it is understood that any suitable arrangement can be used that retains the functions described with respect to the present embodiments.

Although the foregoing has been described with reference to certain specific embodiments, various modifications thereto will be apparent to those skilled in the art without departing from the spirit and scope of the invention as outlined in the appended claims.

1. A sharpening system for a cutting tool having a blade, wherein the blade extends longitudinally along a generally linear path and having opposite longitudinally extending sides and a cutting edge portion along at least one of the sides, wherein the cutting edge portion has opposite planar faces oriented in converging fashion and meeting at a cutting edge of the cutting edge portion, wherein the blade has a body portion adjacent the cutting edge portion and having opposite planar faces oriented in substantially parallel condition to each other, wherein the opposite planar faces of the cutting edge portion respectively form a common acute angle with planes containing the adjacent planar faces of the body portion that defines half of a cutting angle of the blade, the sharpening system comprising:
a support base for supporting the blade in inclined orientation relative to a support surface in which the cutting edge is above an opposite one of the sides of the blade, wherein the support base includes:
an underside defining a plane arranged for resting on the support surface;
a topside opposite to and above the underside; and
a plurality of sidewalls extending upwardly and outwardly from the underside towards the topside as to be arranged to be inclined relative to the support surface, wherein the sidewalls respectively form different acute angles relative to the plane of the underside;
wherein the support base is configured to removably receive the blade in the inclined orientation at each of the sidewalls;
a sharpener distinct from the support base and configured for movement on the support surface, wherein the sharpener comprises a planar grinding surface arranged to be oriented perpendicularly upright to the support surface, wherein the grinding surface is configured to grind the cutting edge portion of the blade when the sharpener is moved relative to the blade in a path following the cutting edge portion; and
a tool for measuring the cutting angle of the blade, wherein the tool comprises:
a body carrying a plurality of slots representative of different cutting angles;
wherein the slots respectively extend from open ends at a periphery of the body to closed ends spaced inwardly therefrom;
wherein each of the slots comprises an opposite pair of sidewalls spaced apart in a width direction of the slot and converging at the closed end;
wherein each of the slots comprises a mouth portion of the sidewalls forming the open end and in which the sidewalls extend linearly inwardly from the periphery of the body in converging fashion, wherein an angle between the sidewalls is associated with a respective one of the different cutting angles represented by the slot;
wherein each slot further comprises an intermediate portion of the sidewalls in which the sidewalls are linear and parallel to each other, wherein at the intermediate portion the sidewalls extend inwardly from the mouth portion by a prescribed depth corresponding to convergence of imaginary lines collinear with the mouth portion, wherein at the intermediate portion the sidewalls are spaced apart by a prescribed width arranged to receive an end portion of the cutting edge portion including and adjacent to the cutting edge; and
wherein each slot further comprises an end portion enlarged in the width direction relative to the intermediate portion and forming the closed end.

2. The sharpening system of claim 1 wherein the prescribed width is between 0.07 mm and 0.14 mm.

3. The sharpening system of claim 1 wherein the body of the tool for measuring the cutting angle is linearly elongated from a first longitudinal end to a second longitudinal end opposite thereto, and wherein opposite longitudinally-extending sides form parallel linear edges.

4. The sharpening system of claim 3 wherein the slots open at a common one of the longitudinally-extending sides of the body.

5. The sharpening system of claim 1 wherein the slots are arranged about the periphery of the body in consecutive order based on the angle between the sidewalls of the respective slots.

6. The sharpening system of claim 1 wherein the body of the tool for measuring the cutting angle is in the form of a plate.

7. The sharpening system of claim 1 wherein a periphery of the support base, a shape of which is defined by the sidewalls, is a polygon.

8. The sharpening system of claim 1 wherein the tool for measuring the cutting angle is configured to be removably attachable to the sidewalls of the support base to form a ledge therewith for supporting the blade of the cutting tool at a spaced height above the support surface.

9. The sharpening system of claim 1 wherein the support base is configured to emit magnetic fields at each of the sidewalls and the body of the tool is ferrous as to be magnetically attracted to the support base.

10. The sharpening system of claim 1 wherein the support base comprises plural support bases each with the sidewalls forming different acute angles relative to the support surface, and wherein one of the support bases includes a top receptacle in the topside thereof sized and shaped to receive the underside of the other one of the support bases.

11. A sharpening system for a cutting tool having a blade, wherein the blade extends longitudinally along a generally linear path and having opposite longitudinally extending sides and a cutting edge portion along at least one of the sides, wherein the cutting edge portion has opposite planar faces oriented in converging fashion and meeting at a cutting edge of the cutting edge portion, wherein the blade has a body portion adjacent the cutting edge portion and having opposite planar faces oriented in substantially parallel condition to each other, wherein the opposite planar faces of the cutting edge portion respectively form a common acute angle with planes containing the adjacent planar faces of the body portion that defines half of a cutting angle of the blade, the sharpening system comprising:
a support base for supporting the blade in inclined orientation relative to a support surface in which the cutting edge is above an opposite one of the sides of the blade, wherein the support base includes:
an underside defining a plane arranged for resting on the support surface;
a topside opposite to and above the underside; and
a plurality of sidewalls extending upwardly and outwardly from the underside towards the topside as to be arranged to be inclined relative to the support surface, wherein the sidewalls respectively form different acute angles relative to the plane of the underside;
wherein the support base is configured to removably receive the blade in the inclined orientation at each of the sidewalls;
a sharpener distinct from the support base and configured for movement on the support surface, wherein the sharpener comprises a planar grinding surface arranged to be oriented perpendicularly upright to the support surface, wherein the grinding surface is configured to grind the cutting edge portion of the blade when the sharpener is moved relative to the blade in a path following the cutting edge portion;
wherein the sharpener comprises:
a handle arranged for gripping by a user, wherein the handle has an axis arranged to be parallel to the support surface and having axially opposite ends;
wherein the handle is supported for rolling movement across the support surface;
a pair of magnetic devices configured to emit magnetic fields and supported at a common one of the ends of the handle in spaced apart relation transversely of the axis;
a pair of receptacles respectively registered with the magnetic devices such that each of the magnetic devices is recessed relative to an axially outwardly facing end of a respective one of the receptacles; and
a grinding pad comprising the planar grinding surface on an outer side thereof and a mounting portion on an opposite inner side, wherein the mounting portion forms a pair of projections which are configured to magnetically attract to the magnetic devices, wherein the projections are sized and shaped to be mateably received in the receptacles such that the grinding pad is removably mountable to the handle.

12. The sharpening system of claim 11 wherein the projections are ferrous.

13. The sharpening system of claim 11 wherein the grinding pad includes at a periphery encompassing the outer and inner sides a notch formed adjacent the inner side as to form in a mounted position of the grinding pad, in which the grinding pad is connected to the handle, a receptacle arranged to receive a prying implement to pull the grinding pad away from the handle.

14. The sharpening system of claim 11 wherein the sharpener further includes wheels at the axially opposite ends of the handle and supporting the handle in said rolling movement, wherein one of the wheels at said common end of the handle forms the receptacles such that the grinding pad is rotatable with the wheel in rolling movement on the support surface.

15. The sharpening system of claim 14 wherein the receptacles are formed through a full thickness of the wheel directed along the axis of the handle, and the magnetic devices are received at an inner side of the wheel facing the handle.

16. The sharpening system of claim 15 wherein inner end portions of the receptacles opening at the inner side of the wheel and receiving the magnetic devices are radially enlarged relative to outer end portions of the receptacles opening at an outer side of the wheel and arranged to receive the projections of the grinding pad, such that the receptacles include intermediate ledges for butting engagement with the magnetic devices to retain the magnetic devices in the inner end portions.

17. A method of using a sharpening system to grindingly sharpen a cutting tool, wherein the cutting tool has a blade extending longitudinally along a generally linear path and having at one or more longitudinally-extending sides thereof a cutting edge portion with opposite planar faces oriented in converging fashion to meet at a cutting edge, the method comprising:
measuring the cutting angle of the blade;
based on the measured cutting angle of the blade, supporting the blade in a prescribed inclined orientation in which the cutting edge is above an opposite one of the sides of the blade, wherein an angle of the prescribed inclined orientation is an acute angle relative to a support surface and equal to 90 degrees less the measured cutting angle;
while the blade is supported in the prescribed inclined orientation, grinding one of the planar faces of the cutting edge portion.

18. The method of claim 17 wherein measuring the cutting angle comprises comparing the cutting edge portion with one or more slots representative of different predetermined cutting angles to identify the cutting angle of the blade.

19. The method of claim 18 wherein comparing the cutting edge portion with the slots comprises inserting the cutting edge portion into said at least one of the slots.

20. The method of claim 17 wherein, when the sharpening system includes a support base having a plurality of inclined sidewalls forming different angles with a plane defining an underside of the support base, supporting the blade in the prescribed inclined orientation based on the measured cutting angle comprises placing the blade in butting engagement with one of the sidewalls of the support base forming said angle of the prescribed inclined orientation.

21. The method of claim 20 wherein, when the sharpening system includes a measuring tool for measuring the cutting angle of the blade that is distinct from the support base, and when the blade is shorter in height between the cutting edge and the opposite longitudinally-extending edge than the sidewalls of the support base, supporting the blade in the prescribed inclined orientation comprises supporting the measuring tool at or adjacent a bottom of said one of the sidewalls to form a ledge at a top of the measuring tool for engaging the opposite longitudinally-extending side of the blade in the prescribed inclined orientation.

22. The method of claim 17 wherein, when the sharpening system includes a grinding sharpener supported for rolling movement on the support surface, and when the sharpening system includes a support base with at least one sidewall for supporting the blade in the prescribed inclined orientation, the method further includes, after grinding one of the planar faces of the cutting edge portion, storing the sharpener with its rotational axis oriented upright in a top receptacle in the support base.
